(19) United States
(12) Patent Application Publication
(10) Pub. No.: US 2010/0318425 A1
(43) Pub. Date: Dec. 16, 2010

(54) SYSTEM AND METHOD FOR PROVIDING A PERSONALIZED SHOPPING ASSISTANT FOR ONLINE COMPUTER USERS

(76) Inventors: Meherzad Ratan Karanjia, Mumbai (IN); Rashmi Sasidharan, Mumbai (IN); Sapana Gupta, Mumbai (IN)

Correspondence Address: SCHWEGMAN, LUNDBERG & WOESSNER/EBAY, P.O. BOX 2938, MINNEAPOLIS, MN, 55402, US

(21) Appl. No.: 12/483,910

(22) Filed: Jun. 12, 2009

(51) Int. Cl. G06Q 30/00; G06F 17/30

(52) U.S. Cl. 705/14.66; 707/759; 707/769; 707/754

(57) ABSTRACT

A system and method for providing a personalized shopping assistant for online computer users is disclosed. A particular embodiment includes prompting for personalized profile data related to a consumer; associating the personalized profile data with one or more item feature sets; using the one or more item feature sets to qualify a search performed on an item listing database to produce filtered search results; and presenting the filtered search results to a user.

### TECHNICAL FIELD

This application relates to a method and system for use with an electronic commerce system, according to one embodiment, and more specifically, for providing a personalized shopping assistant for online computer users.

### BACKGROUND

Buying consumer products and services in a market place full of choices can often be a tedious task. The shopping process for on-line users can be even more difficult. The current search functionality of most product search engines on the Internet includes an implicit assumption that the user has a reasonably strong clarity of his/her needs. For example, while buying a mobile phone, a conventional search engine may enable the user to choose amongst various parameters like brand, the camera pixel, Bluetooth requirement, FM requirement, email needs, etc. However, what the user really wants to buy is the perfect phone that matches his/her requirements and his/her personality. The experience that today's Internet search engines provide is very different from the experience the consumer has in a physical store, where the salesman will ask a couple of questions, make certain judgments about the consumer and suggest a few options that the salesman thinks are best suited for the customer's needs.

Thus, a system and method for providing a personalized shopping assistant for online computer users is needed.

### BRIEF DESCRIPTION OF THE DRAWINGS

The various embodiments is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 is a block diagram illustrating an example embodiment of multiple network and marketplace applications, respectively, which are provided as part of a network-based marketplace;

FIG. 3 is a high-level entity-relationship diagram, according to an example embodiment, illustrating various tables that may be maintained within a database to support networking and marketplace applications;

FIGS. 4-6 illustrate example embodiments of functional modules pertaining to some of the applications of FIG. 2;

FIGS. 7-8 are flow charts illustrating example embodiments of methods for implementing a personalized shopping assistant;

FIGS. 9-10 illustrate an example embodiment of a method for associating the personalized profile data with one or more item feature sets including mapping consumer responses to item feature sets maintained in a database;

FIG. 11 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In one embodiment, a system and method for providing a personalized shopping assistant for online computer users is disclosed. In various example embodiments, an application aims to simplify the shopping experience on a host site, such as an on-line commerce site, an auction site, or other product/service or broker site. A particular embodiment can use an application programming interface (API) Web application that can make use of host site search and other API's to provide search results to buyers in a simpler and less traditional format. Search results can be customized according to personalized shopping profile information associated with one or more particular consumers. The personalized shopping profile information can be generated and processed based on user/consumer responses to queries prompted by the personalized shopping assistant. The idea is to replicate the presence of a salesman in an offline store, who can deduce buying preferences from a consumer's responses, age, gender, and other cues. While traditional search engines use data such as price range, type of item, etc. to provide search results, various embodiments described herein can use a series of questions and/or implicit information to gain insight into a consumer/user's psychographics, preferences, and style of shopping to show search results that are a closer match to the user's/consumer's needs and preferences. The various embodiments aim to bring a more human approach to the on-line shopping experience, break down the search experience into simpler, intuitive steps, and provide search results to the user that are narrower and more closely fit the user's preferences.

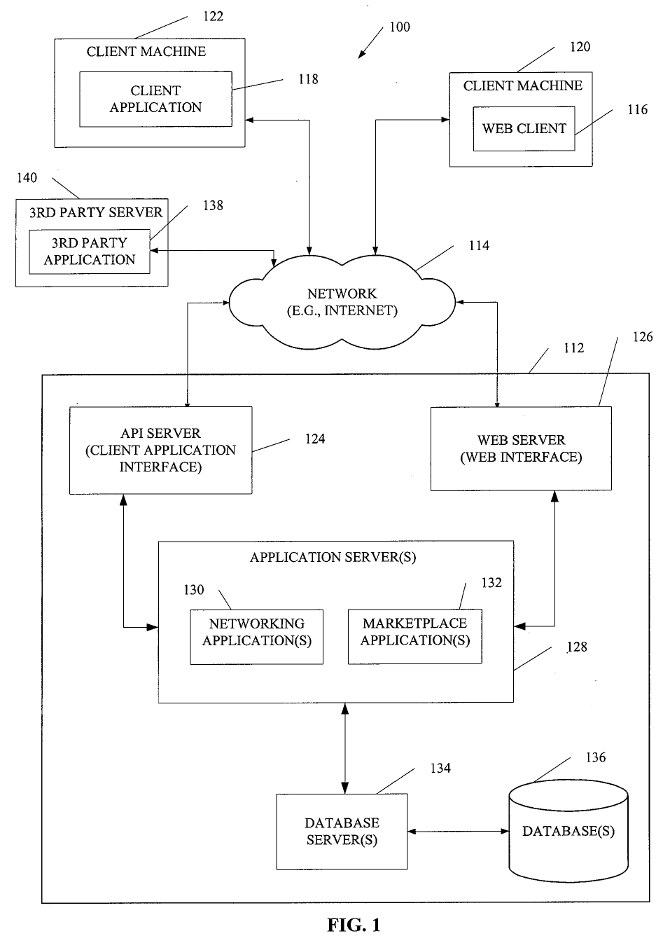

FIG. 1 is a network diagram depicting a network system 100, according to one embodiment, having a client-server architecture configured for exchanging data over a network. For example, the network system 100 may be a trading/commerce system where clients may communicate and exchange data with the trading/commerce system, the data may pertain to various functions (e.g., online purchases) and aspects (e.g., managing social networks) associated with the network system 100. Although illustrated herein as a client-server architecture for simplicity, in other embodiments the network architecture may vary and include an architecture such as a peer machine in a peer-to-peer (or distributed) network environment.

Returning to FIG. 1, a data exchange platform, in an example form of a network-based provider 112, provides server-side functionality, via a network 114 (e.g., the Internet) to one or more clients. The one or more clients may include users that may utilize the network system 100 and more specifically, the network-based provider 112, to exchange data over the network 114. These transactions may include transmitting, receiving (communicating) and processing data to and from the multitude of users. The data may include, but is not limited to, user preference information, shopping profile information, shopping context identifiers, context data, notations (e.g., personal and public shopping notes), context filter data, shared electronic shopping carts, product and service reviews, product, service, manufacture, and vendor recommendations and identifiers, product and service listings associated with buyers and sellers, auction bids, feedback, etc. In one embodiment, the personalized shopping profile information can be associated with one or more contexts generated by a user or other users and maintained on the network-based provider 112. Data associated with a personalized shopping profile, such as any of the data described above, may be publicly shared as determined by the originator of the data.

Turning specifically to the network-based marketplace 112, an application program interface (API) server 124 and a web server 126 are coupled to, and provide programmatic and web interfaces respectively to, one or more application servers 128. The application servers 128 host one or more networking application(s) 130 and marketplace application(s) 132. The application servers 128 are, in turn, shown to be coupled to one or more databases servers 134 that facilitate access to one or more databases 136.

In one embodiment, the web server 126 may send and receive data pertaining to a personalized shopping profile via a toolbar installed on a browser application. The toolbar may allow for a user or a third party to, inter alia, create a new personalized shopping profile (a personalized profile creator), selectively add a uniform resource locator (URL) associated with the created personalized shopping profile, and create notations regarding research and general matters associated with the personalized shopping profile. In other embodiments, the web server may serve a page or the API server 124 in conjunction with the client application 118 may provide the same or similar functionality as that described with reference to the toolbar. It may be noted that using a toolbar within an application such as a browser or stand alone application is well known in the art.

The marketplace application(s) 132 may provide a number of marketplace functions and services (e.g., item listing, payment, etc.) to users that access the network-based marketplace 112. The networking application(s) 130 likewise may provide a number of consumer services, merchant services, or social networking services and functions to users. The networking application(s) 130 may allow a user to generate one or more contexts related to shopping, which may include personalized shopping profiles (e.g., for products and services) couched as a broad category associated with a consumer, a class of consumers, and/or an item (e.g., a product or service) or class of items. Additionally, personalized shopping profiles can be couched as associated with a specific consumer or a specific item. For example, a personalized shopping profile in the form of a category could be, “women over 40 years old” or “purchasers of digital cameras.” An example of a personalized shopping profile in a more specific form may be, “a personalized shopping profile for John A. Smith of Akron, Ohio” or “purchasers of Canon digital cameras.” The level of specificity may vary and is selectable by the personalized shopping profile creator or personalized shopping assistant user. For example, the personalized shopping profile could be as specific as a particular person or make, model, additional specific attributes or features of a specific item.

In one embodiment, the networking application(s) 130 and marketplace application(s) 132 may provide a client (e.g., web client 116) with an interface that includes input fields for personality or item attributes most commonly selected by other users as the most important or most determinative attributes related to the products/services which a user/consumer is seeking. For example, a multitude of users may have indicated they thought the most important personality attributes for the personalized shopping profile include information related to: 1) consumer/user need, 2) general consumer/user personality, 3) consumer/user shopping attitude, and 4) consumer/user budget. A multitude of other users may have indicated they thought the most important item attributes for a digital camera purchaser personalized shopping profile include: 1) digital camera brand, 2) pixel count, 3) zoom, and 4) size. These personalized shopping profile attributes may be independently developed or discovered by the network-based marketplace 112 by processing the attribute data received from the multitude of users or may be based on the personalized shopping profile creator ranking the attributes or a combination thereof.

The networking application(s) 130 may allow the personalized shopping profile creator or personalized shopping assistant user to distribute the one or more personalized shopping profiles to one or more groups defined by the personalized shopping profile creator or personalized shopping assistant user (e.g., “my family,” “my friends,” etc.) or to groups at various levels in a predefined category (e.g., “photography group,” “digital camera group,” or “Canon digital camera group,” etc.).

While the networking application(s) 130 and the marketplace application(s) 132 are shown in FIG. 1 to form part of the network-based marketplace 112, it will be appreciated that, in alternative embodiments, the networking application(s) 130 may form part of a social networking service that is separate and distinct from the network-based marketplace 112.

FIG. 1 also illustrates a third party application 138, executing on a third party server machine 140, as having programmatic access to the network-based marketplace 112 via the programmatic interface provided by the API server 124. For example, the third party application 138 may, utilizing information retrieved from the network-based marketplace 112, support one or more features or functions on a website hosted by the third party. The third party website may, for example, provide one or more networking, marketplace or payment functions that are supported by the relevant applications of the network-based marketplace 112.

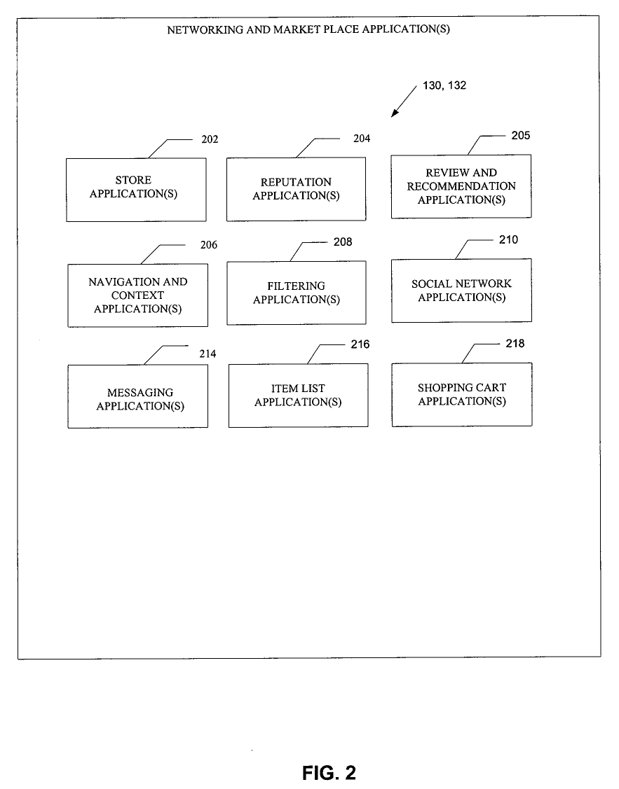

FIG. 2 is a block diagram illustrating an example embodiment of multiple network and marketplace application(s) 130 and 132, respectively, which are provided as part of the network-based marketplace 112. The network-based marketplace 112 may provide a number of personalized profile based shopping, context based shopping, social networking, and listing and price-setting mechanisms whereby a seller may list goods and/or services (e.g., for sale) and a buyer may buy or bid on listed goods and/or services. Another user or group member associated with a community group interested or associated with the personalized profile or context provided and shared by the personalized profile creator may offer or provide information that may be helpful in assisting the personalized profile creator or personalized shopping assistant user in customizing their shopping experience pertaining to the personalized profile. For example, another user or group member may provide a review of or recommendation list on a specific group of consumers or items corresponding to a particular personalized profile. Among various embodiments, the recommendations, reviews, or research notes corresponding to the personalized profile may be directed from another user to one or more users desiring data associated with the personalized profile or the data may be provided from storage by the network and marketplace application(s) 130 and 132 based on the personalized profile provided by the personalized profile creator. The data may be provided based on a request from the personalized profile creator or automatically pushed to the personalized profile creator based on policy or a user configuration file.

To this end, the network and marketplace application(s) 130 and 132, respectively, are shown to include one or more application(s) which support the network-based marketplace 112, and more specifically the generation and maintenance of one or more personalized shopping profiles provided by users of the network-based marketplace 112 or personalized shopping assistant users. These applications can include support for activities associated with the personalized profiles, including storing and retrieving user notes, web sites (URLs), links associated with related tags, research and notes from other users and community members, related community groups, vendors, providing localized geographic data for personalized profiles (e.g., regional consumer purchasing patterns), etc. Additionally, the various applications may support social networking functions, including building and maintaining the community groups created by a user, which may be helpful in providing various types of data (e.g., reviews, notes, local services, consumer information, etc.) pertaining to the personalized profiles.

Store application(s) 202 may allow sellers to group their listings (e.g., goods and/or services) within a “virtual” store, which may be branded and otherwise personalized by and for the sellers. Such a virtual store may also offer promotions, incentives and features that are specific and personalized to a relevant seller and consumer. In one embodiment, based on the personalized profiles provided by the personalized profile creator, the virtual store may be provided to the personalized profile creator or personalized shopping assistant user where the virtual store may carry or sell an item or service related to a user's need based on the personalized profile.

Reputation application(s) 204 may allow parties that transact utilizing the network-based marketplace 112 to establish, build, and maintain reputations, which may be made available and published to potential trading partners. Consider that where, for example, the network-based marketplace 112 supports person-to-person trading, users may have no history or other reference information whereby the trustworthiness and/or credibility of potential trading partners may be assessed. The reputation application(s) 204 may allow a user, for example through feedback provided by other transaction partners, to establish a reputation within the network-based marketplace 112 over time. Other potential trading partners may then reference such a reputation for the purposes of assessing credibility, trustworthiness, or the like. A user creating a personalized profile and seeking reviews, research (e.g, notes, etc.), and recommendations associated with the personalized profile may filter the result data from the search or context submission based on reputation data. For example, the personalized profile creator may only want personalized profile data such as reviews and research notes pertaining to the personalized profile from other users with a greater than 3 out of 5 star reputation rating.

In one embodiment, the network-based marketplace 112 includes review and recommendation application(s) 205. The social networking application(s) 210 may work in conjunction with the review and recommendation application(s) 205 to provide a user interface to facilitate the entry of reviews of the personalized profile data received from other users. A review may be a text entry of the community group member's opinion, a standard review form including check boxes indicating a level satisfaction, or a combination of both, etc. Recommendations may include a specific type of demographic, item, a specific brand or service for a type of item, a specific retailer for the item, etc.

Navigation of the network-based marketplace 112 may be facilitated by one or more navigation and context application(s) 206. For example, a context application may, inter alia, enable key word searches of item listings associated with a context defined by a personalized profile of a particular consumer. The context can include an association between the personalized profile data in the personalized profile and item feature sets related to items in the item listings. The item listings can include listings from a group including products or services or both. The item feature set data and data defining the association between the personalized profile data in the personalized profile and item feature sets may be retrieved from the network-based marketplace 112 (e.g., databases 136) or from various other remote sources, such as other network sites, other users (e.g., experts or peers), etc. In one embodiment, a toolbar installed on a browser application may be used for functions including interactive and navigation functions to create a new personalized profile, selectively add a uniform resource locator (URL) associated with the created personalized profile, and create notations regarding research and general matters associated with the personalized profile. These functions may be user accessible by many methods known in the art, including a web form interface (HTML or embedded Java) or a stand alone application interface. For example, a navigation application may include a browser that allows users via an associated user interface to browse a user's personalized profile, various item listings, item feature sets, contexts, catalogues, inventories, social networks, and review data structures within the network-based marketplace 112. In one embodiment, the user interface includes selectable elements in the form of tabs to separate out various categories of personalized profile data that when selected generate a list associated with the category. For example, a tab for “My Notes,” a tab for “Everyone's Notes,” a tab for “Buy,” and a tab for “Sell”. Various other navigation applications (e.g., an external search engine) may be provided to supplement the search and browsing applications.

In one embodiment, using filtering application(s) 208, the personalized profile creator or personalized shopping assistant user may customize result data associated with a personalized profile. The filtering application(s) 208 may generate the result data according to one or more rules provided by the network-based marketplace 112 and the user receiving the filtered result data. For example, as discussed above with reference to the reputation application(s) 204, the personalized profile creator may only want the personalized profile to match on item listings pertaining to item reviews from other users with a greater than 3 out of 5 star reputation rating. In another example, the personalized profile creator may only want personalized profile data to match on item listings pertaining to item listings with a particular feature set or attribute set. For example, the personalized profile creator may only want result data for digital cameras with equal or greater than 5 megapixels. Additionally, the filtering rules may be combinable or modifiable to broaden or narrow the scope of the result data.

The filtering application(s) 208 may also be used to implement rules for granting or allowing access to the personalized profile creator's personalized profile data, such as the personalized profile creator's personalized profile(s) and associated research (e.g., notes, URLs, etc.).

Messaging application(s) 214 may be used for the generation and delivery of messages to users of the network-based marketplace 112. For example, the personalized profile creator may like a particular review or research from another user and may wish to contact the user for additional information. In one embodiment, the messaging application(s) 214 may be used in conjunction with the social networking application(s) 210 to provide promotional and/or marketing (e.g., targeted advertisements associated with the personalized profile) to the personalized profile creator or a related user from vendors and community members that may have offerings related to the personalized profile.

Item list application(s) 216 may be used in the network-based marketplace 112 by the personalized profile creator to create an item list based on selecting one or more items and services to purchase (or sell), which may be at least partially based on result data associated with the personalized profile creator's shopping experience. The item list application(s) 216 may be accessed via a user interface that allows the user to create and use the item list. Additionally, the personalized profile creator may selectively share this list within a community or to all users to gain or solicit additional data such as vendor recommendations for each purchase or vendor reviews for vendors that may be present in the list.

In one embodiment, electronic shopping cart application(s) 218 are used to create a shared electronic shopping cart used by a personalized profile creator to add and store items from a shopping list generated by the personalized profile creator (e.g., by making selections from a “Buy” tab). The electronic shopping cart application(s) 218 may facilitate the transactions for each item on the list by automatically finding the items in the electronic shopping cart across at least one or all of a set of vendors, a comparison shopping site, an auction site, other user's ads, etc. In one embodiment, a multitude of transactions may appear as one transaction based on the selection of “Bulk Purchase.” In various embodiments, the selection criteria for which vendor or vendors to purchase from may include, but is not limited to, criteria such as lowest cost, fastest shipping time, preferred or highest rated vendors or sellers, or any combination thereof.

It will be appreciated that one or more of the various example networking and marketplace application(s) 130, 132 may be combined into a single application including one or more modules. Further, in some embodiments, one or more applications may be omitted and additional applications may also be included.

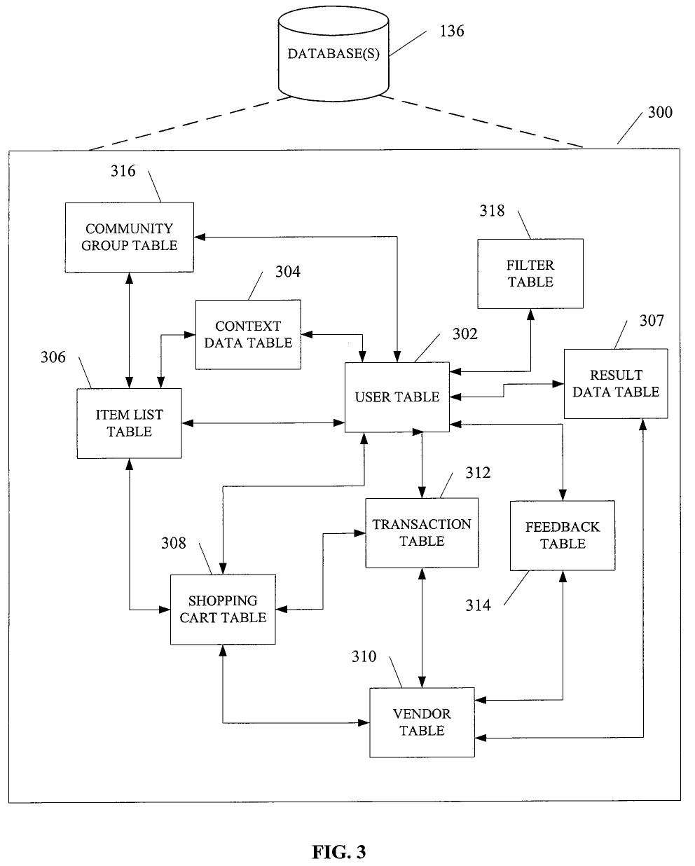

FIG. 3 is a high-level entity-relationship diagram, in accordance with an example embodiment, illustrating various tables 300 that may be maintained within the database(s) 136 (see FIG. 1), which may be utilized by and support the networking and marketplace application(s) 130 and 132, respectively. A user table 302 may contain a record for each registered user of the network-based marketplace 112, and may include identifier, address and financial instrument information pertaining to each such registered user. In one embodiment, a user operates as one or all of a personalized profile creator, a seller, a buyer, within the network-based marketplace 112.

The context data table 304 maintains a record of the one or more personalized shopping profiles created by a personalized profile creator (user). As discussed above, this may include personalized profile identifiers that may include words and/or phrases from the general to the specific for a consumer class, specific consumer, product/service class, or a specific product/service. Context data in context data table 304 can also include associations between the personalized profile data in the personalized consumer profiles and item feature sets related to items in the item listings. The item listings can be listings for products or services or both. The personalized consumer profiles, item feature set data, and data defining the association between the personalized profile data in the personalized consumer profiles and item feature set data may be stored into or retrieved from the context data table 304 of database(s) 136. In one embodiment, each word in a phrase may be a tag linked to another personalized profile and its associated data. For example “Canon” may be a selectable element within the user interface as a tag that results in the selector receiving more general data regarding Canon products. Similarly, “camera” may be selected to receive more general data regarding cameras, in this case both digital and film cameras.

The tables 300 may also include an item list table 306 which maintains listing or item records for goods and/or services that were created using the item list application(s) 216. In various embodiments, the item list may be created and shared with a community group or to all users in part to solicit feedback regarding listed or potential vendors.

Each listing or item record within the item list table 306 may furthermore be linked to one or more electronic shopping cart records within a electronic shopping cart table 308 and to one or more user records within the user table 302 and/or a vendor table 310, so as to associate a seller or vendor and one or more actual or potential buyers from the community group with each item record.

A transaction table 312 may contain a record for each transaction pertaining to items or listings for which records exist within the item list table 306. For example, the transaction table 312 may contain a purchase or sales transaction of an item of the item list by a consumer.

In one example embodiment, a feedback table 314 may be utilized by one or more of the reputation application(s) 204 to construct and maintain reputation information associated with users (e.g., members of the community group, sellers, etc.).

Group(s) of users found in a community group table 316 may be selected by a user to be members of a community group having access to personalized profile data and an item listing associated with the electronic shopping cart.

A filter table 318 may be used to sort and filter data associated with a personalized profile. The sorted or filtered data are then stored in the result data table 307 and linked to the personalized profile creator via a personalized profile identifier. Various types of filters and associated rules were discussed above with reference to the filtering application(s) 208 in FIG. 2.

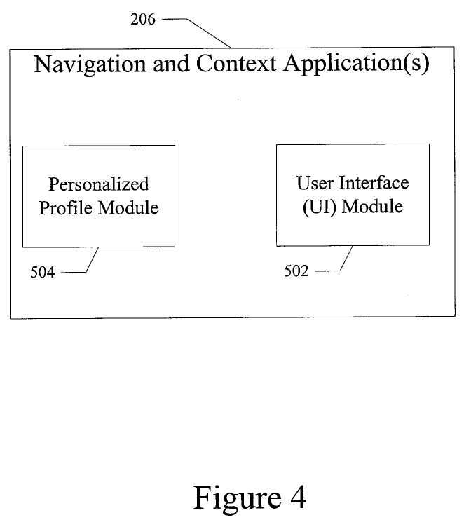

FIGS. 4-6 illustrate example embodiments of functional modules pertaining to some of the applications of FIG. 2. It will be appreciated that the applications and associated modules may be executed within any portion of the network system 100, (e.g., the client machine 122 and the network-based marketplace 112). Additionally, the modules discussed herein are for example only and it can be appreciated these modules and applications may be combined into one or many modules and applications without departing from the spirit of the methods and systems described herein.

FIG. 4 is a block diagram illustrating an example embodiment of a user interface module 502 which may be utilized by the navigation and context application(s) 206. In one embodiment, the user interface module 502 may provide a personalized profile creator or personalized shopping assistant user with a user interface (e.g., toolbar on a browser application) for creating or using a personalized profile to be communicated back to the network-based marketplace 112. The personalized profile module 504 processes the personalized profile generated and used as discussed above with reference to FIGS. 1, 2, and 3.

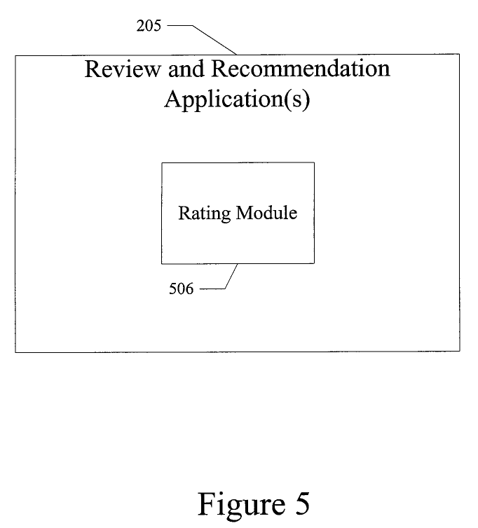

The user interface module 502 may also work in conjunction with the rating module 506 of the review and recommendation application(s) 205 (see FIG. 5) to provide an interface for the personalized profile creator to rank filtered result data received in response to a search performed with a particular personalized profile. In one embodiment, the ranking of the result data is performed locally, while in another embodiment the ranking is communicated and stored at the network-based marketplace 112 for subsequent retrieval.

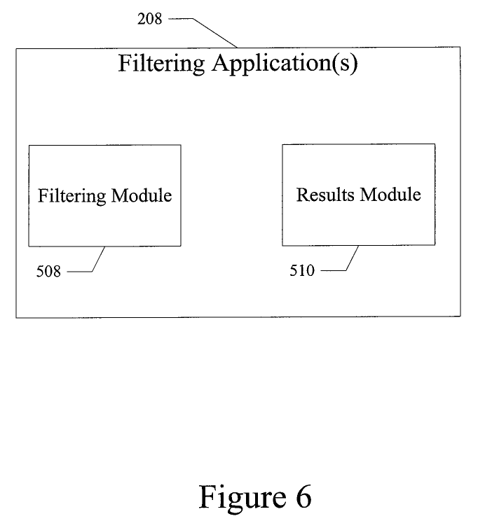

FIG. 6 illustrates the filtering application(s) 208, which includes a filter module 508 and a results module 510. In one embodiment, the filter module 508 may be used along with a results module 510 to filter and create rules associated with producing desired result data. As described above, the personalized shopping assistant can be used to perform a search and produce filtered results that conform to a previously generated personalized profile. Examples of result data filtering based on rules are discussed above with reference to FIGS. 1, 2, and 3.

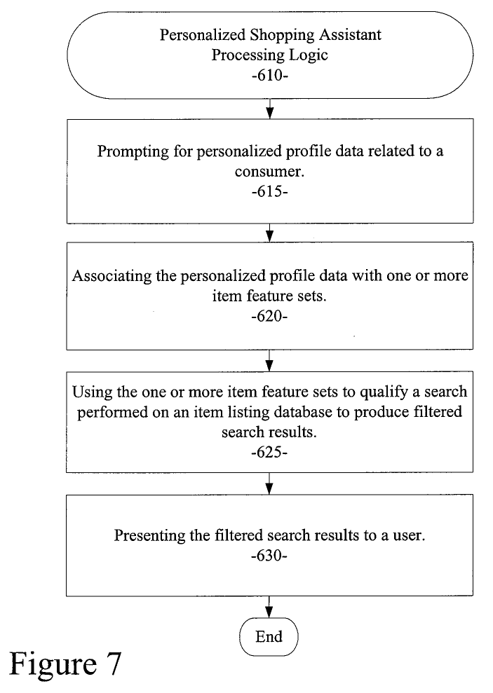

FIG. 7 is a processing flow chart illustrating an example embodiment 610 of a personalized shopping assistant. The method of an example embodiment includes: prompting for personalized profile data related to a consumer (processing block 615); associating the personalized profile data with one or more item feature sets (processing block 620); using the one or more item feature sets to qualify a search performed on an item listing database to produce filtered search results (processing block 625); and presenting the filtered search results to a user (processing block 630).

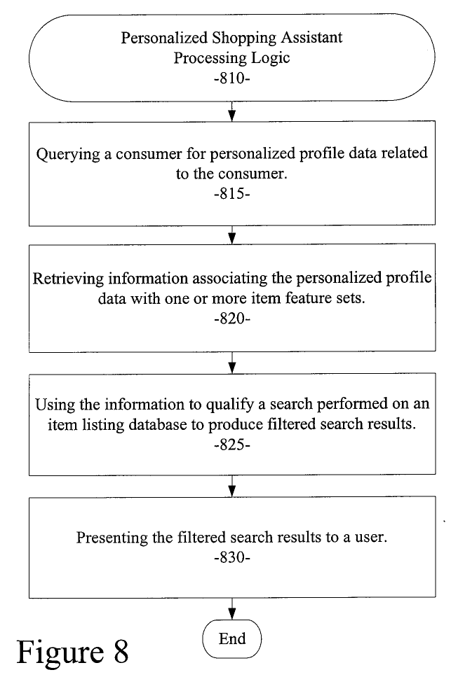

FIG. 8 is a processing flow chart illustrating another example embodiment 810 of a personalized shopping assistant. The method of an example embodiment includes: querying a consumer for personalized profile data related to the consumer (processing block 815); retrieving information associating the personalized profile data with one or more item feature sets (processing block 820); using the information to qualify a search performed on an item listing database to produce filtered search results (processing block 825); and presenting the filtered search results to a user (processing block 830).

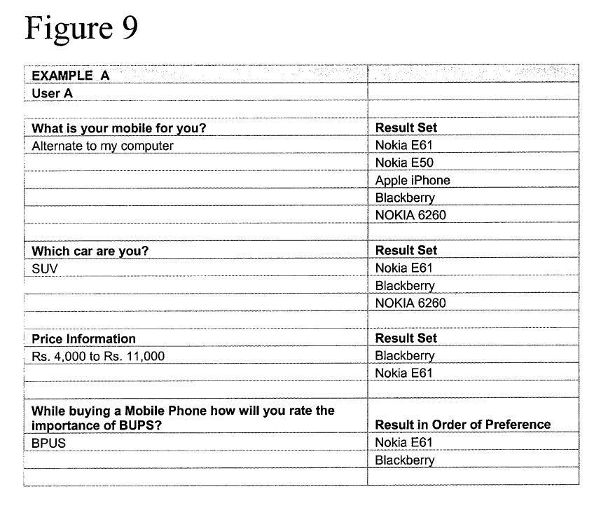

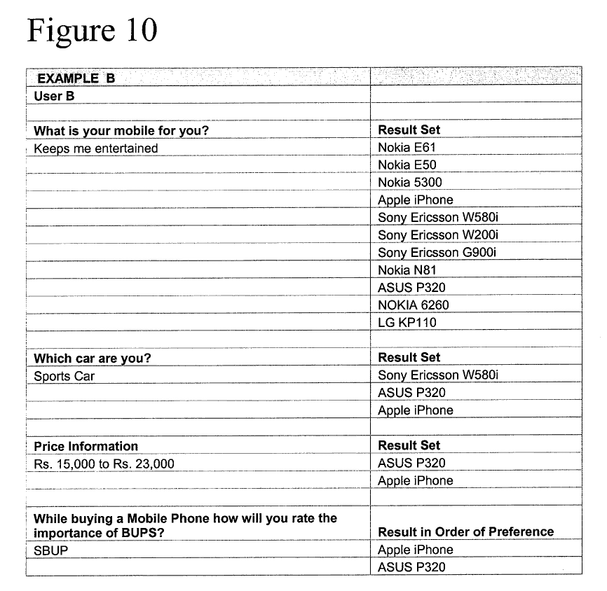

FIGS. 9 and 10 illustrate an example embodiment of a method for associating the personalized profile data with one or more item feature sets includes mapping consumer responses to item feature sets maintained in a database. In the example shown, an association is formed between shopping-related responses provided by a user/consumer and corresponding feature attributes or feature sets of items that may be related to the consumer responses. In a particular embodiment, a user/consumer can be prompted or queried by asking a few very specific questions related to the user's shopping needs, overall shopping preferences, and personal preferences. The personalized shopping assistant of a particular embodiment can deduce from the user responses various information related to the user's personality, shopping behavior, budget, and the like. Based on the automatically deduced consumer information, the personalized shopping assistant of a particular embodiment can then offer the consumer a selection of various items (e.g., products and/or services), which are closest to the consumer's needs. Further, the personalized shopping assistant can be applied to any category of items listed on a host site.

In order to illustrate an example of the operation of a particular embodiment with reference to FIGS. 9 and 10, we have used a “Mobile phones” or “cellphones” item category that may be offered on a particular host site. Note that any type of product or service offerings can be similarly used for a particular embodiment as described herein.

### Recognizing the User Need:

In a particular embodiment, a buyer's need in this example category (i.e.: “Mobile phones” or “cellphones”) can be divided into six (more or less are possible) specific buckets or segments (listed below). New buckets can be created for this example category as innovations/new features are introduced in the mobile handset industry. In order to recognize the user's needs for items in this category, the personalized shopping assistant of a particular embodiment can prompt the user with a query or set of queries, the responses to which can be used to deduce the user's needs. Answers to this question can be mapped to features of a phone, and each answer can be automatically used to choose product features that best corresponds with the user's need. For example, if a user chooses ‘alternate to computer’ as an option, the item listings of products can be sorted to show items that necessarily have email applications, Bluetooth, QWERTY keyboard, touch screen etc. An example query is presented below and shown in FIGS. 9 and 10.
Question 1:
What is your phone for you?

1. Keeps me entertained

2. Lets me capture memories

3. Is a great accessory/something to show off

4. Alternate to my computer

5. Keeps me in touch with my loved ones

6. I don't miss it

A particular user/consumer can respond to the question above with any one of the six answer options provided. As shown in the example of FIG. 9, a sample user A has responded with Answer 4 (Alternate to my computer). Using a set of pre-defined item feature set associations, as shown in the right-hand column of FIG. 9, this user answer can be associated with item features that most likely relate to the selected answer. In this manner, the user's answer to the query can be used to deduce the user/consumer's most likely desired item features for a mobile handset, in the example shown.

As shown in the example of FIG. 10, a sample user B has responded with Answer 1 (Keeps me entertained). Using the set of pre-defined item feature set associations, as shown in the right-hand column of FIG. 10, this user answer can be associated with item features that most likely relate to User B's selected answer. In this manner, User B's answer to the query can be used to deduce User B's most likely desired item features for a mobile handset, in the example shown.

### Understanding User's Personality:

In a particular embodiment, we see a significant similarity or correlation in a person's choice of Mobile Phone and his/her choice of car. The same has been corroborated by offline surveys. This question attempts to draw a parallel between the user's personality and therefore the kind of phone s/he is most likely to buy. The car type can be used to find answers to two questions—style consciousness of the user and utility consciousness of the user. For example, a person who sees himself/herself as a sports car may prefer sleek and young looking phones with features that are the latest in the market, such as touch screen. Alternatively, a person with compact car as a preference may not want phones that are very bulky and may look for more functional orientation than features that look cool. To gain an insight into the user's personality, the user can be prompted to answer the following question.
Question 2:
Which car are you?

1. Compact Car

2. Sedan

3. Sporty/Convertible

4. SUV/Mini Van

A particular user/consumer can respond to the question above with any one of the four answer options provided. As shown in the example of FIG. 9, a sample user A has responded with Answer 4 (SUV/Mini Van). Using the set of pre-defined item feature set associations, as shown in the right-hand column of FIG. 9, this user answer can be associated with item features that most likely relate to the selected answer. In this manner, the user's answer to the query can be used to deduce the user/consumer's most likely desired item features for a mobile handset, in the example shown.

As shown in the example of FIG. 10, a sample user B has responded with Answer 3 (Sporty/Convertible). Using the set of pre-defined item feature set associations, as shown in the right-hand column of FIG. 10, this user answer can be associated with item features that most likely relate to User B's selected answer. In this manner, User B's answer to the query can be used to deduce User B's most likely desired item features for a mobile handset, in the example shown. Understanding the user's shopping attitude:

Key decision influencers for a shopper are brand, utility, style, and price of the product/service. However, for different sets of users, the importance of each parameter can be different. For example, it may be most important for a particular consumer that the product is good-looking, while s/he pays lesser importance to the brand and price. To gain an insight into the user's shopping attitude, the user can be prompted to answer the following question.
Question 3:
While buying a Mobile Phone, how will you rate the importance of the following?

1. Brand

2. Utility

3. Style

4. Price

A particular user/consumer can respond to the question above by ranking the four answer options provided. For example, the consumer can enter BPUS, indicating that the particular consumer rates Brand as most important, Price as next important, Utility as next important, and Style as least important. As shown in the example of FIG. 9, a sample user A has responded with Answer BPUS, as indicating their rating of buying decision influencers. Using the set of pre-defined item feature set associations, as shown in the right-hand column of FIG. 9, this user answer can be associated with item features that most likely relate to the selected answer. In this manner, the user's answer to the query can be used to deduce the user/consumer's most likely desired item features for a mobile handset, in the example shown.

As shown in the example of FIG. 10, a sample user B has responded with Answer SBUP (, indicating that the particular consumer rates Style as most important, Brand as next important, Utility as next important, and Price as least important.). Using the set of pre-defined item feature set associations, as shown in the right-hand column of FIG. 10, this user answer can be associated with item features that most likely relate to User B's selected answer. In this manner, User B's answer to the query can be used to deduce User B's most likely desired item features for a mobile handset, in the example shown.

### Finding the User's Budget:

The previous question in the example of a particular embodiment tells us about the importance of price in the overall shopping experience for a particular consumer. This question can further help in getting closer to the price point the user/consumer has in mind. For example, if a user/consumer picks a price range of Rs. (Indian Rupees) 4,000 to Rs. 11,000, and had previously responded that price is a least important decision parameter for him/her, the user/consumer can be shown products in the price range of Rs. 8,000 to Rs. 11,000 (that is, a price range within the upper limits of the specified price range). Conversely, if a user/consumer picks a price range of Rs. 4,000 to Rs. 11,000, and had previously responded that price is a most important decision parameter for him/her, the user/consumer can be shown products in the price range of Rs. 4,000 to Rs. 8,000 (that is, a price range within the lower limits of the specified price range). To gain further insight into the user's budget, the user can be prompted to answer the following question.
Question 4:
The price range in which you are looking is:

1. Less than Rs. 4,000

2. Rs. 4,000-Rs. 11,000

3. Rs. 11,000-Rs. 15,000

4. Rs. 15,000-Rs. 23,000

5. Rs. 23,000 and above

A particular user/consumer can respond to the question above with any one of the five answer options provided. As shown in the example of FIG. 9, a sample user A has responded with Answer 2 (Rs. 4,000-Rs. 11,000). Using the set of pre-defined item feature set associations, as shown in the right-hand column of FIG. 9, this user answer can be associated with item features that most likely relate to the selected answer. In this manner, the user's answer to the query can be used to deduce the user/consumer's most likely desired item features for a mobile handset, in the example shown.

As shown in the example of FIG. 10, a sample user B has responded with Answer 4 (Rs. 15,000-Rs. 23,000). Using the set of pre-defined item feature set associations, as shown in the right-hand column of FIG. 10, this user answer can be associated with item features that most likely relate to User B's selected answer. In this manner, User B's answer to the query can be used to deduce User B's most likely desired item features for a mobile handset, in the example shown.

Thus, for each of the queries given to or prompted of a user/consumer by the personalized shopping assistant of a particular embodiment, the user/consumer responses can used to deduce the user/consumer's most likely desired item features for items for which the user/consumer is shopping at an on-line host site.

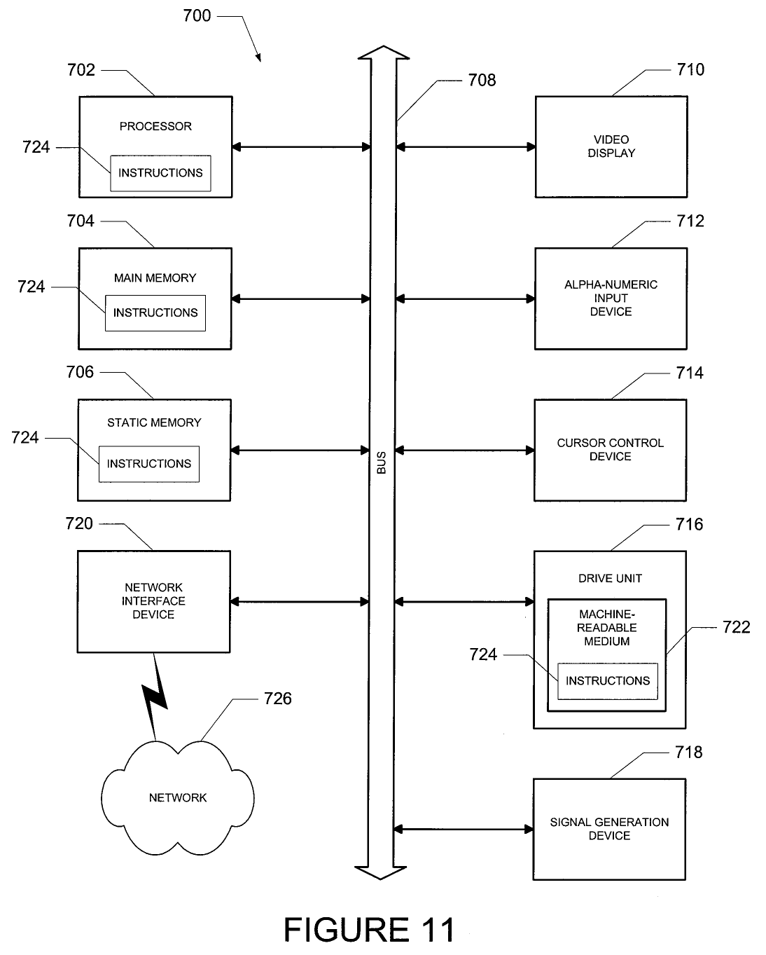

FIG. 11 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

We claim:

1. A method, including:
prompting for personalized profile data related to a consumer;
associating the personalized profile data with one or more item feature sets;
using the one or more item feature sets to qualify a search performed on an item listing database to produce filtered search results; and
presenting the filtered search results to a user.

2. The method of claim 1, wherein the personalized profile data includes at least one type of data from a group including: data describing a consumer's needs, data describing a consumer's personality, data describing a consumer's demographics, data describing a consumer's shopping attitude, and data describing a consumer's budget.

3. The method of claim 1, wherein the item listing database lists items from at least one type of listings in a group including: a product and a service.

4. The method of claim 1 wherein associating the personalized profile data with one or more item feature sets includes mapping consumer responses to item feature sets maintained in a database.

5. The method of claim 1, including grouping the result data according to a personalized profile data identifier.

6. The method of claim 1, further including:
receiving a rating from the user pertaining to the filtered search results; and
further filtering the filtered search results according to the rating.

7. The method of claim 1, further including:
associating an advertisement from a third party pertaining to personalized profile data; and
providing the advertisement to a user interface of the user.

8. The method of claim 1, including selectively providing at least a portion of the personalized profile data associated with the user to another user based on one or more rules.

9. The method of claim 1, including selectively updating the filtered search results based on receiving new data associated with the personalized profile data.

10. A system, comprising:
a personalized profile module to prompt for personalized profile data related to a consumer;
a filtering module to associate the personalized profile data with one or more item feature sets, and to use the one or more item feature sets to qualify a search performed on an item listing database to produce filtered search results; and
a user interface module to present the filtered search results to a user.

11. The system of claim 10, wherein the personalized profile data includes at least one type of data from a group including: data describing a consumer's needs, data describing a consumer's personality, data describing a consumer's demographics, data describing a consumer's shopping attitude, and data describing a consumer's budget.

12. The system of claim 10, wherein the item listing database lists items from at least one type of listings in a group including: a product and a service.

13. The system of claim 10, wherein associating the personalized profile data with one or more item feature sets includes mapping consumer responses to item feature sets maintained in a database.

14. The system of claim 10, being further configured to group the filtered search results according to a personalized profile data identifier.

15. The system of claim 10, being further configured to:
receive a rating from the user pertaining to the filtered search results; and
further filter the filtered search results according to the rating.

16. The system of claim 10, being further configured to:
associate an advertisement from a third party pertaining to personalized profile data; and
provide the advertisement to a user interface of the user.

17. The system of claim 10, being further configured to selectively provide at least a portion of the personalized profile data associated with the user to another user based on one or more rules.

18. The system of claim 10, being further configured to selectively update the filtered search results based on receiving new data associated with the personalized profile data.

19. A machine-readable medium embodying instructions which, when executed by a machine, cause the machine to:
prompt for personalized profile data related to a consumer;
associate the personalized profile data with one or more item feature sets;
use the one or more item feature sets to qualify a search performed on an item listing database to produce filtered search results; and
present the filtered search results to a user.

20. The machine-readable medium of claim 19, wherein the personalized profile data includes at least one type of data from a group including: data describing a consumer's needs, data describing a consumer's personality, data describing a consumer's demographics, data describing a consumer's shopping attitude, and data describing a consumer's budget.

21. A method, including:
querying a consumer for personalized profile data related to the consumer;
retrieving information associating the personalized profile data with one or more item feature sets;
using the information to qualify a search performed on an item listing database to produce filtered search results; and
presenting the filtered search results to a user.

22. The method of claim 21, wherein the personalized profile data includes at least one type of data from a group including: data describing a consumer's needs, data describing a consumer's personality, data describing a consumer's demographics, data describing a consumer's shopping attitude, and data describing a consumer's budget.
